(19) United States
(12) Patent Application Publication
(10) Pub. No.: US 2015/0278375 A1
(43) Pub. Date: Oct. 1, 2015

(54) MULTI-OBJECTIVE OPTIMIZATION FOR NEW MEMBERS OF A SOCIAL NETWORK

(71) Applicant: LinkedIn Corporation, Mountain View, CA (US)

(72) Inventors: Hyung Jin Kim, Mountain View, CA (US); Samir M. Shah, San Francisco, CA (US); Mitul Tiwari, Mountain View, CA (US)

(21) Appl. No.: 14/565,112

(22) Filed: Dec. 9, 2014

Related U.S. Application Data
(60) Provisional application No. 61/972,736, filed on Mar. 31, 2014.

(51) Int. Cl. G06F 17/30

(52) U.S. Cl. CPC G06F 17/30867; G06F 17/3053

(57) ABSTRACT

This disclosure relates to systems and methods that include an electronic database related to members in a social network, the members including new members who have been members of the social network less than a predetermined time and established members who have been members of the social network greater than the predetermined time. A processor, coupled to the electronic database and the network interface, is configured to obtain an optimization criterion based on at least two constraints related to interaction of members in the social network, determine proposed interaction values based on the data, each proposed interaction value corresponding to pairs of members, the proposed interaction values including a new member proposed interaction value between at least one established member and at least one new member, modify the new member proposed interaction value based on an adjustment factor, and provide proposed interactions based the interaction values.

### PRIORITY

This application claims the benefit of priority to U.S. Provisional Patent Application No. 61/972,736, “SYSTEM AND METHOD FOR MULTI-OBJECTIVE OPTIMIZATION FOR NEW MEMBERS OF A SOCIAL NETWORK”, which is incorporated herein by reference in its entirety.

### TECHNICAL FIELD

The subject matter disclosed herein generally relates to utilizing a multi-objective optimization for new members of a social network.

### BACKGROUND

Social networks conventionally connect various users with one another so as to facilitate interaction between users. A potential new user may be identified based on connections of the potential new user with current users of the social network or other sources. The potential new user may then be invited to join the social network. When a new user joins the social network the new user may be presented with mechanisms by which the user may find other members and organizations of the social network with which to connect. For instance, the social network may obtain information about the new user of the social network and, based on that information, determine other users of the social network who the new user may know. The social network may then present those users who the new user may know and invite the new user to connect with those users. Relatedly, when a new user joins then current users who may know the new user may also be presented with an invitation to connect with the new user.

### BRIEF DESCRIPTION OF THE DRAWINGS

Some embodiments are illustrated by way of example and not limitation in the figures of the accompanying drawings.

FIG. 1 is a block diagram illustrating various components or functional modules of a social network, in an example embodiment.

FIG. 2 illustrates a “people you may know” window in a user interface as provided by a social network on a user device associated with a member of the social network, in an example embodiment.

FIG. 3 is an abstract and simplified depiction of a social graph illustrating connections and potential connections between members of a social network, in an example embodiment.

FIG. 4 illustrates a Pareto curve that may be generated by a multi-objective optimization module, in an example embodiment.

FIG. 5 is a flowchart for multi-objective optimization for new members of a social network, in an example embodiment.

FIG. 6 is a block diagram illustrating components of a machine able to read instructions from a machine-readable medium.

### DETAILED DESCRIPTION

Example methods and systems are directed to multi-objective optimization for new users of a social network. Examples merely typify possible variations. Unless explicitly stated otherwise, components and functions are optional and may be combined or subdivided, and operations may vary in sequence or be combined or subdivided. In the following description, for purposes of explanation, numerous specific details are set forth to provide a thorough understanding of example embodiments. It will be evident to one skilled in the art, however, that the present subject matter may be practiced without these specific details.

Having more users of a social network and more active users of the social network are not necessarily tied to one another. The social network may send out many invitations to potential users of the social network who do not then become active participants in the social network and who instead quickly become dormant members or who leave the social network altogether. Moreover the steps that may be taken to increase total membership may also tend to increase the percentage of users who are dormant or who ultimately leave the social network.

Thus, the technical activities performed by the social network to increase membership and activity may produce inefficiencies in the operations and goals of the social network. Such activities may consume both the active resources of the social network, in that superfluous or unproductive invitations may be generated and transmitted to potential new members. Further, the storage resources of the social network may be inefficiently utilized in storing the necessary information related to the maintenance of member profiles and content of members who do not ultimately become productive members of the social network.

A multi-objective optimization technique has been developed to foster both increased membership in a social network and increase the activity of new users of the social network upon the new users becoming members of the social network. In particular, new members of the social network may be made more likely to be presented to existing members of the social network as people that the existing members may know. Upon being presented to existing members as someone who the existing members may know, the existing members may be more likely than may otherwise be the case to invite the new member to connect in the social network.

The multi-objective optimization technique may seek to maximize members of the social network by increasing new members and by increasing a number of connections within the social network that new members tend to have. Such a “connection density” may be obtained by increasing a likelihood of such new members being presented as a “person you may know” to existing members. By increasing their connection density, new members may be more likely to remain members and to be active member of the social network. The principles described herein may apply equally well to other combinations of constraints, such as by substituting connection density with other member interaction, such as endorsements.

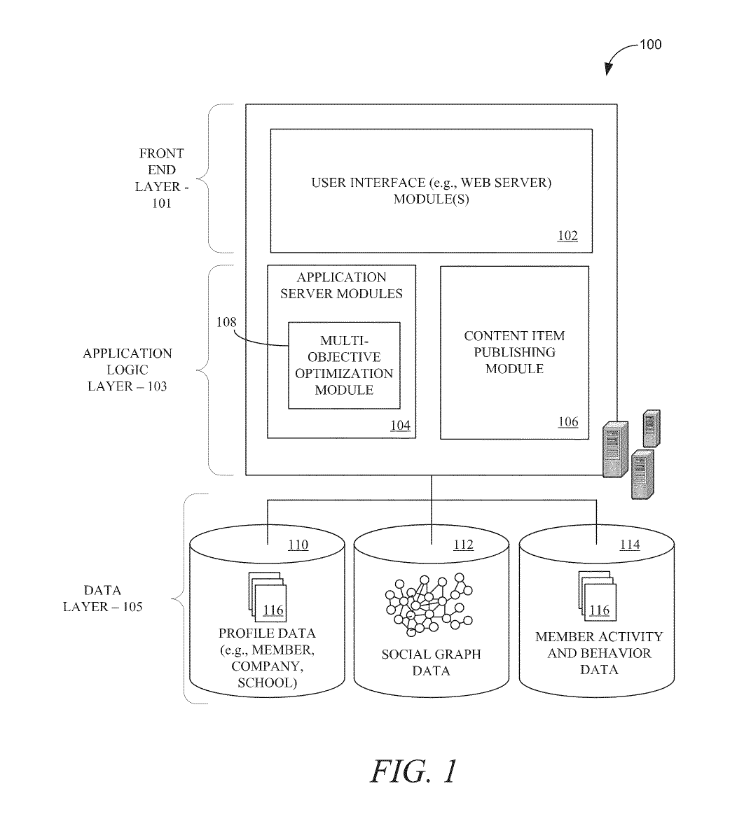

FIG. 1 is a block diagram illustrating various components or functional modules of a social network 100, consistent with some examples. The social network 100 may be utilized to provide treaded electronic messages within the user interface of the social network 100. While the threading of electronic messages are described with particular respect to the social network 100, it is to be recognized and understood that the principles described with respect to threaded electronic messages may be applied to any of a variety of platforms and electronic messages beyond those directly applicable to a social network generally.

A front end 101 consists of a user interface module (e.g., a web server) 102, which receives requests from various client-computing devices, and communicates appropriate responses to the requesting client devices. For example, the user interface module(s) 102 may receive requests in the form of Hypertext Transport Protocol (HTTP) requests, or other web-based, application programming interface (API) requests. An application logic layer 103 includes various application server modules 104, which, in conjunction with the user interface module(s) 102, may generate various user interfaces (e.g., web pages, applications, etc.) with data retrieved from various data sources in a data layer 105. In some examples, individual application server modules 104 may be used to implement the functionality associated with various services and features of the social network service. For instance, the ability of an organization to establish a presence in the social graph of the social network 100, including the ability to establish a customized web page on behalf of an organization, and to publish messages or status updates on behalf of an organization, may be services implemented in independent application server modules 104. Similarly, a variety of other applications or services that are made available to members of the social network service may be embodied in their own application server modules 104. Alternatively, various applications may be embodied in a single application server module 104.

The application server modules 104 may include the capacity to determine, based on information in various databases disclosed below, people who members of the social network 100 may know and facilitate a social network connection between the two members. Further, the application server module 104 may identify potential members of the social network 100 and invite those potential members to join the social network 100, such as via electronic message. The application server module 104 may utilize various criteria to identify potential connections and potential new members, as is detailed herein.

In some examples, the social network 100 includes a content item publishing module 106, such as may be utilized to receive content, such as electronic messages, posts, links, images, videos, and the like, and publish the content to the social network. The one or more of the application server modules 104, the content item publishing module 106, or the social network 100 generally may include a multi-objective optimization module 108. As will be disclosed in detail herein, the multi-objective optimization module 108 may manage electronic messages and organize and display such electronic messages according to objectives determined by the administrators of the social network.

As illustrated, the data layer 105 includes, but is not necessarily limited to, several databases 110, 112, 114, such as a database 110 for storing profile data, including both member profile data as well as profile data for various organizations. Consistent with some examples, when a person initially registers to become a member of the social network service, the person may be prompted to provide some personal information, such as his or her name, age (e.g., birthdate), gender, interests, contact information, home town, address, the names of the member's spouse and/or family members, educational background (e.g., schools, majors, matriculation and/or graduation dates, etc.), employment history, skills, professional organizations, and so on. This information is stored, for example, in the database 110. Similarly, when a representative of an organization initially registers the organization with the social network service, the representative may be prompted to provide certain information about the organization. This information may be stored, for example, in the database 110, or another database (not shown). With some examples, the profile data may be processed (e.g., in the background or offline) to generate various derived profile data. For example, if a member has provided information about various job titles the member has held with the same or different companies, and for how long, this information can be used to infer or derive a member profile attribute indicating the member's overall seniority level, or seniority level within a particular company. With some examples, importing or otherwise accessing data from one or more externally hosted data sources may enhance profile data for both members and organizations. For instance, with companies in particular, financial data may be imported from one or more external data sources, and made part of a company's profile.

Once registered, a member may invite other members, or be invited by other members, to connect via the social network service. A “connection” may require a bi-lateral agreement by the members, such that both members acknowledge the establishment of the connection. Similarly, with some examples, a member may elect to “follow” another member. In contrast to establishing a connection, the concept of “following” another member typically is a unilateral operation, and at least with some examples, does not require acknowledgement or approval by the member that is being followed. When one member follows another, the member who is following may receive status updates or other messages published by the member being followed, or relating to various activities undertaken by the member being followed. Similarly, when a member follows an organization, the member becomes eligible to receive messages or status updates published on behalf of the organization. For instance, messages or status updates published on behalf of an organization that a member is following will appear in the member's personalized data feed or content stream. In any case, the various associations and relationships that the members establish with other members, or with other entities and objects, are stored and maintained within the social graph database 112.

The social network service may provide a broad range of other applications and services that allow members the opportunity to share and receive information, often customized to the interests of the member. For example, with some examples, the social network service may include a photo sharing application that allows members to upload and share photos with other members. With some examples, members may be able to self-organize into groups, or interest groups, organized around a subject matter or topic of interest. With some examples, the social network service may host various job listings providing details of job openings with various organizations. As members interact with the various applications, services and content made available via the social network service, information concerning content items interacted with, such as by viewing, playing, and the like, etc.) may be monitored and information concerning the interaction may be stored, for example, as indicated in FIG. 1 by the database 114.

The various databases 110, 112, 114 may obtain information from members and users of the social network 100 related to other members and potential members of the social network 100 who the various members and users may know. For instance, the profile database 110 may include information that a potential member and a current member graduated in the same class or work or worked at the same employer together. The social graph database 112 may identify potential “people you may know” based on a proximity of two members to one another in the social graph, such as according to a degree of separation to one another in the social graph. Someone may be likely to know someone else if the members have two (2) or three (3) degrees of separation. Similarly, the member activity and behavior database 114 may include information that members or a member and potential member are on the same electronic message distribution list, part of the same group, commented on the same content items, have exchanged electronic messages within or outside of the social network 100, and so forth.

Although not shown, with some examples, the social network 100 provides an application programming interface (API) module via which third-party applications can access various services and data provided by the social network service. For example, using an API, a third-party application may provide a user interface and logic that enables an authorized representative of an organization to publish messages from a third-party application to various content streams maintained by the social network service. Such third-party applications may be browser-based applications, or may be operating system-specific. In particular, some third-party applications may reside and execute on one or more mobile devices (e.g., phone, or tablet computing devices) having a mobile operating system.

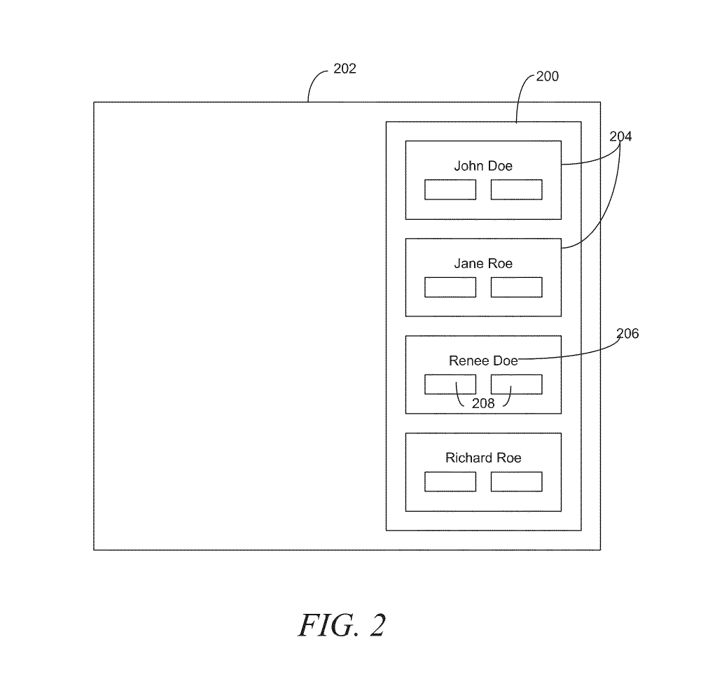

FIG. 2 illustrates a “people you may know” window 200 in a user interface 202 as provided by the social network 100 on a user device associated with a member of the social network 100, in an example embodiment. The people you may know window 200 may be generated by the application server module 104 based on information obtained from the databases 110, 112, 114. The window 200 includes individual frames 204. Each of the frames includes an identifier 206 of a member of the social network 100 with whom the member to whom the window 200 is presented may connect. Each frame further includes one or more buttons 208 with which the member to whom the window 200 is presented may either invite the member in the frame 204 to make a connection or to decline to invite the member in the frame 204 to form a connection.

The applications server module 104 may include a framework for identifying people you may know recommendations that are relatively more or less likely to result in a connection being made. Each factor that tends to suggest that two members may be likely to know one another may contribute to an aggregate score for the potential connection. Thus, the number of degrees of separation between members may have a factor (e.g., two degrees of separation may be worth 1.0, three degrees of separation may be worth 0.6, four degrees of separation may be worth 0.2, and so forth), common associations, such as schools, employers, groups, and the like, may have a factor (e.g., at least two common associations may be worth 1.0 and one common association may be worth 0.5), and related interactions, such as interacting with the same content item or electronic messaging one another may have a factor (e.g., 0.3 for interacting with the same content item and 0.3 for messaging one another). The factors may be averaged, aggregated, or otherwise combined to produce a person you may know value between potential connections in the social network.

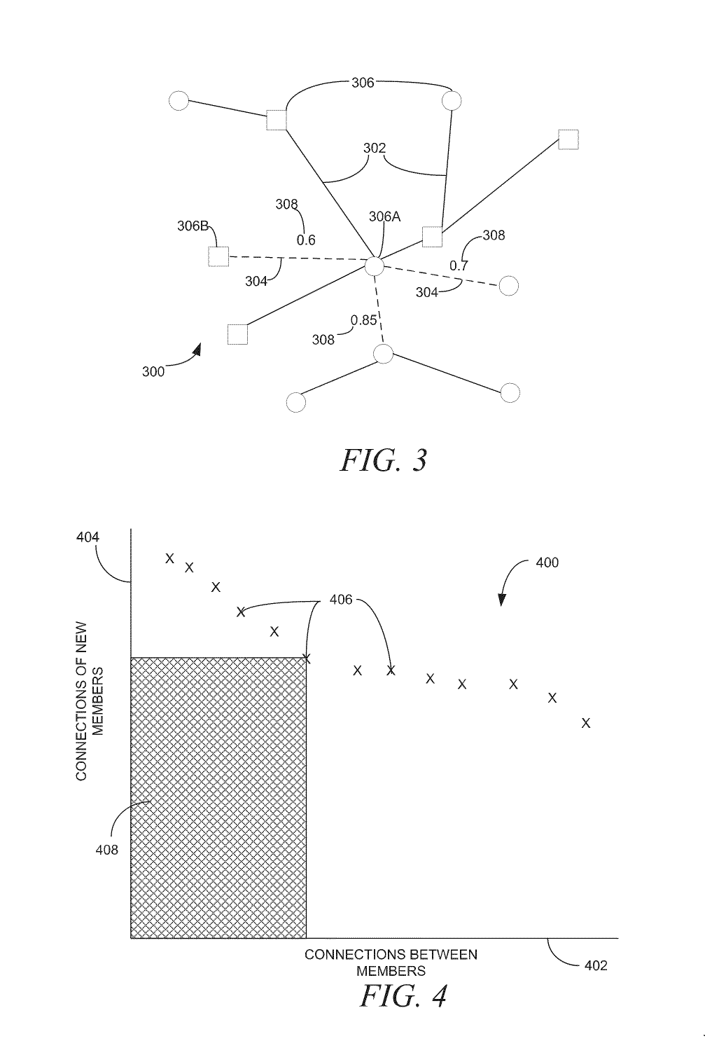

FIG. 3 is an abstract and simplified depiction of a social graph 300 illustrating connections 302 and potential connections 304 between members 306 of the social network 100, in an example embodiment. The potential connections 304 are labeled with a person you may know value 308 which may be an aggregate of various person you may know factors disclosed herein. The higher the person you may know value 308, the more and/or stronger factors there may be that tend to suggest that the associated members may be to connect with one another.

Social networks may generally be considered stronger the more connections 302 that are made between members 306 of the social network 100. Thus, the person you may know function of the application server module 104 and as presented on the window 200 of the user interface 202 may promote the most absolute connections 302 within the social graph 300 by presenting in the people you may know window 200 those potential connections 304 that have the highest factors.

However, seeking to maximize total connections 302 immediately may tend to result in relatively few connections 302 where one of the members 306 is a new member of the social network 100 and thus may have relatively fewer factors that contribute to a relatively high person you may know value 308. For instance, as illustrated, the member 306A is an established member of the social network 100 while the member 306B is a new member, e.g., has been a member of the social network 100 less than thirty (30) days. The person you may know value 308 between the two members 306A, B is lower than between the member 306A and other members 306. Thus, the new member 306B would not be displayed in the top four frames 204 as illustrated in the window 200 based simply on the value 308.

The multi-objective optimization module 108 is configured to provide as an operating condition for the social network 100 an adjustment factor to the value 308 to facilitate new members 306 making connections 302. The multi-objective optimization module 108 may vary the adjustment factor based on feedback of the results the adjustment factor as previously applied. The multi-objective optimization module 108 may generate such an adjustment factor and make such adjustment based on an optimization criterion. The optimization criterion may allow for one constraint to potentially reduce in order to allow another constraint to improve.

In various examples, the optimization criterion may be to maximize both a number of new connections 302 between members 306 and new connections 302 between members 306, one of whom is a new member 306B. Applying the adjustment factor to a potential connection 304 with a new member 306B, the potential connection 304 may be less likely 304 to turn into an actual connection 302 than if a potential connection 304 with a higher person you may know value 308 were displayed in the given frame 204. As a result, seeking to specifically increase connections 302 with new members 306B may tend to reduce total connections 302. Additionally or alternatively, the optimization criterion may seek to maximize the number of invitations to form new connections 302 and a number of invitations to form a connection 302 with a new member 306. In other words, the metric may be, or may be supplemented with invitations to form connections 302 instead of or in addition to actual connections 302.

In an example, a new user 306B may receive an adjustment factor if the new user 306B has been a member of the social network 100 for thirty (30) days or fewer and has fewer than thirty (30) connections 302. The adjustment factor may be added to the value 308 to obtain an adjusted value that may be compared against other values 308 for selecting which potential connections 304 will be reflected in the people you may know window 200 and individual frames 204. The adjustment factor may be based on an adjustment score, such as may be determined by the equation:

Adjustment score=1/(1+log(number of connections))

The “number of connections” may be a number of connections 302 between the new user 306B and other members of the social network 100. The adjustment score may be multiplied by a constant to arrive at the adjustment factor. The constant may be adjustable by the multi-objective optimization module 108 as feedback on the results of the adjustment factor as applied is obtained. Thus, if total new connections 302 are too low then the constant may be decreased while if the new user connections are too low then the constant may be increased. In various examples, the constant is between zero (0) and one (1).

In an example, by selecting a constant of 0.3, the number of total invitations to form a new connection 302 between members 306 may decrease by approximately 0.3 percent and the number of new connections 302 between members 306 may decrease by approximately 0.8 percent. By contrast, with the constant of 0.3, the number of invitations to form a connection 302 with a new member 306B may increase by 7.7 percent and the number of connections 302 with a new member 306B may increase by 7.3 percent.

The multi-objective optimization module 108 may seek to optimize the constraints by varying the constant over time and, using feedback, identify a constant that produces an optimized result. Additionally or alternatively, the multi-objective optimization module 108 may utilize data in the databases 110, 112, 114 to estimate a constant that may produce an optimized result. For instance, the multi-objective optimization module 108 may obtain data from the member activity and behavior database 114 that identifies how many people you may know impressions have been made in the windows 200 of the users of the social network 100 and what values 308 corresponded to the impressions that resulted in connections 200. Based on a distribution of the values 308 that lead to connections 302, it may be estimated how applying adjustment factors to those values 308 may result in new connections 302.

FIG. 4 illustrates a Pareto curve 400 that may be generated by the multi-objective optimization module 108, in an example embodiment. The multi-objective optimization module 108 may analyze a variety of and resultant connections formed between members 402 and connections 302 formed with or by new members 404, among various potential metrics. The connections of the new members may be between an individual new member 306B and any other member 306 of the social network, whether a different new member 306 or a long-standing member 306 of the social network. Each point 406 on the curve 400 may represent a different constant value. The constant value may be applied over a predetermined period of time, such as from one (1) to fifteen (15) days. The Pareto curve 400 is a mechanism for illustrating the relationship between results from different constants and it is to be understood that the multi-objective optimization module 108 does not necessarily require an actual curve 400 to determine a constant that corresponds to an actual result.

The optimized constant may be identified or chosen based on any of a variety of chosen factors. In an example, the optimization criterion may require that total new connections 302 not fall below a predetermined threshold and otherwise to utilize the constant that produces the most connections 302 with new members. In an alternative example, the optimization criterion may provide that whatever constant produces the greatest area 408 on the curve 400. Additional or alternative factors may be implemented for selecting a constant that is implemented.

The constant may be subject to regular updating, such as by changing the constant moderately, such as by one (1) to five (5) percent, and determining if the result with the new constant is better than with the previous constant. In an example, every month the constant may be adjusted to one or more provisional values and the results compared against the original constant. If a provisional constant produce a better result than the original constant per the optimization criterion then the provisional may be implemented as the constant moving forward.

The principles disclosed herein may be applied to any of a number of circumstances that may tend to encourage new user engagement with the social network 100. For instance, the social network 100 may provide for members endorsing one another for skills, may provide for groups and other associations, members, groups, or organizations that the user may want to follow, and the like. Such categories may be applied as constraints in the manner described herein with respect to connections and utilized to encourage new member engagement with the social network 100, perhaps at the expense of engagement with the social network 100 by other members or at the expense of other social network factors.

The term “optimized” and related words should not be taken as meaning strictly optimized or maximized for the purposes of this disclosure. Thus, the optimization techniques do not necessarily require finding an absolutely optimal or maximized operating condition for the social network 100. Moreover, a maximally optimized operating condition that is determined may not necessarily be utilized and a less than maximally optimized operating condition may be selected instead, such as if, in the above example, a relatively small decrease in revenue may produce a relatively large increase in user engagement. The multi-objective optimization module 108 may be configured with logic that would allow for, for instance, selecting a revenue total that is 0.2 percent less than the maximum value for a two (2) percent relative increase in engagement.

### Flowchart

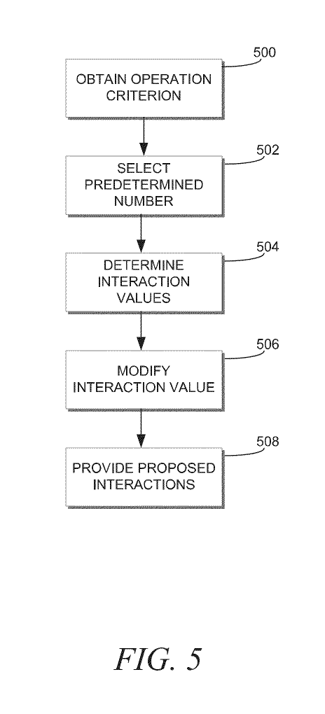

FIG. 5 is a flowchart for multi-objective optimization for new members of a social network, in an example embodiment. The flowchart may be performed with any of a variety of devices and systems disclosed herein, as well as with any suitable system known in the art.

At operation 500, an optimization criterion is obtained with a processor based on at least two constraints related to interaction of members of a social network, the members including new members who have been members of the social network less than a predetermined time and established members who have been members of the social network greater than the predetermined time. In an example, one of the at least two constraints is a connection in the social network between the established member and the new member. In an example, another one of the at least two constraints is a connection between any of the members of the social network. In an example, the optimization criterion is to increase new connections between new members of the social network and all members of the social network. In an example, the optimization criterion is measured over a predetermined period of time.

At operation 502, a predetermined number of proposed interactions is selected by the processor based, at least in part, on a new member proposed interaction value and the proposed interaction values.

At operation 504, a plurality of proposed interaction values is determined with the processor based on data stored in an electronic database, the data being indicative of at least some of profile data of members of a social network, a social graph indicative of connections between the members, and of activities of the members in the social network, each individual one of the plurality of proposed interaction values corresponding to between one of a plurality of pairs of members, the plurality of proposed interaction values including a new member proposed interaction value between at least one established member and at least one new member.

At operation 506, the new member proposed interaction value is modified, with the processor, based on an adjustment factor. In an example, the adjustment factor includes a constant selectable by the processor to at least partially provide the operating condition. In an example, the adjustment factor further includes an adjustment score based, at least in part, on a degree of separation between the new member and the established member.

At operation 508, proposed interactions are provided, with the processor, to at least some of the user devices via the network interface, based on the new member proposed interaction value as modified and the proposed interaction value. In an example, providing the proposed interactions includes providing the proposed interactions in an order according to the proposed interaction value as modified and the proposed interaction value. In an example, providing includes providing a predetermined number of proposed interactions and further comprising.

In an example, the content items include organic content items provided to the social network by the users of the social network and sponsored content items provided to the social network by sponsors of the content items, and wherein the operating condition is based, at least in part, on a percentage mix of organic content items and sponsored content items. In an example, providing the social network is by arranging the content items within positions in a newsfeed. In an example, the content items include organic content items provided to the social network by the users of the social network and sponsored content items provided to the social network by sponsors of the content items, and wherein the operating condition is based, at least in part, on a separate percentage mix of organic content items and sponsored content items within individual positions. In an example, providing the social network is based, at least in part, on the operating condition to all of the users of the social network.

### System

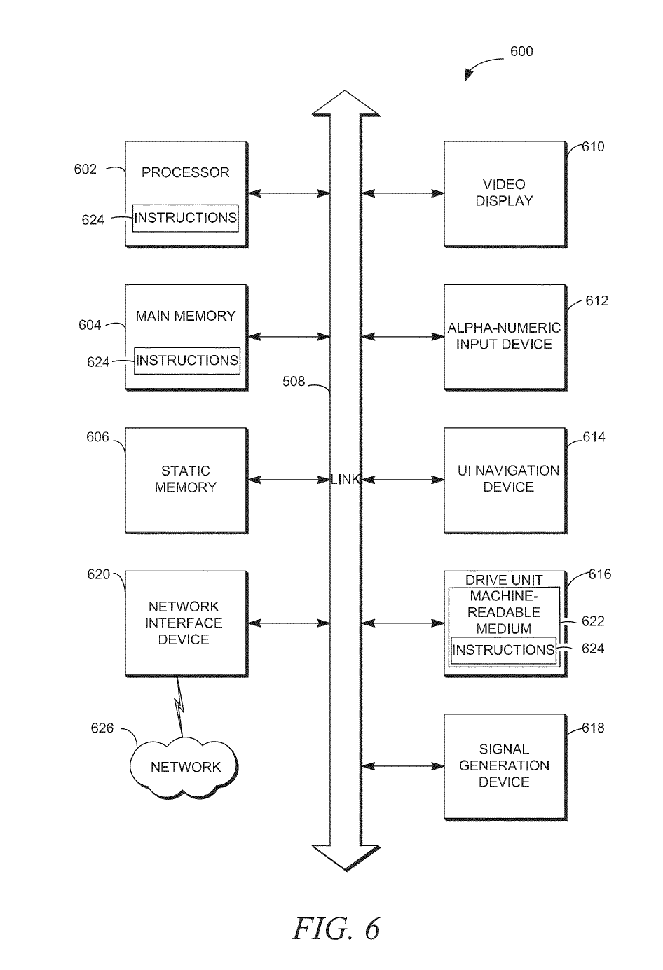

FIG. 6 is a block diagram illustrating components of a machine 600, according to some example embodiments, able to read instructions from a machine-readable medium (e.g., a machine-readable storage medium) and perform any one or more of the methodologies discussed herein. Specifically, FIG. 6 shows a diagrammatic representation of the machine 600 in the example form of a computer system and within which instructions 624 (e.g., software) for causing the machine 600 to perform any one or more of the methodologies discussed herein may be executed. In alternative embodiments, the machine 600 operates as a standalone device or may be connected (e.g., networked) to other machines. In a networked deployment, the machine 600 may operate in the capacity of a server machine or a client machine in a server-client network environment, or as a peer machine in a peer-to-peer (or distributed) network environment. The machine 600 may be a server computer, a client computer, a personal computer (PC), a tablet computer, a laptop computer, a netbook, a set-top box (STB), a personal digital assistant (PDA), a cellular telephone, a smartphone, a web appliance, a network router, a network switch, a network bridge, or any machine capable of executing the instructions 624, sequentially or otherwise, that specify actions to be taken by that machine. Further, while only a single machine is illustrated, the term “machine” shall also be taken to include a collection of machines that individually or jointly execute the instructions 624 to perform any one or more of the methodologies discussed herein.

The machine 600 includes a processor 602 (e.g., a central processing unit (CPU), a graphics processing unit (GPU), a digital signal processor (DSP), an application specific integrated circuit (ASIC), a radio-frequency integrated circuit (RFIC), or any suitable combination thereof), a main memory 604, and a static memory 606, which are configured to communicate with each other via a bus 608. The machine 600 may further include a graphics display 610 (e.g., a plasma display panel (PDP), a light emitting diode (LED) display, a liquid crystal display (LCD), a projector, or a cathode ray tube (CRT)). The machine 600 may also include an alphanumeric input device 612 (e.g., a keyboard), a cursor control device 614 (e.g., a mouse, a touchpad, a trackball, a joystick, a motion sensor, or other pointing instrument), a storage unit 616, a signal generation device 618 (e.g., a speaker), and a network interface device 620.

The storage unit 616 includes a machine-readable medium 622 on which is stored the instructions 624 (e.g., software) embodying any one or more of the methodologies or functions described herein. The instructions 624 may also reside, completely or at least partially, within the main memory 604, within the processor 602 (e.g., within the processor's cache memory), or both, during execution thereof by the machine 600. Accordingly, the main memory 604 and the processor 602 may be considered as machine-readable media. The instructions 624 may be transmitted or received over a network 626 via the network interface device 620.

As used herein, the term “memory” refers to a machine-readable medium able to store data temporarily or permanently and may be taken to include, but not be limited to, random-access memory (RAM), read-only memory (ROM), buffer memory, flash memory, and cache memory. While the machine-readable medium 622 is shown in an example embodiment to be a single medium, the term “machine-readable medium” should be taken to include a single medium or multiple media (e.g., a centralized or distributed database, or associated caches and servers) able to store instructions. The term “machine-readable medium” shall also be taken to include any medium, or combination of multiple media, that is capable of storing instructions (e.g., software) for execution by a machine (e.g., machine 600), such that the instructions, when executed by one or more processors of the machine (e.g., processor 602), cause the machine to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” shall accordingly be taken to include, but not be limited to, one or more data repositories in the form of a solid-state memory, an optical medium, a magnetic medium, or any suitable combination thereof.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. Modules may constitute either software modules (e.g., code embodied on a machine-readable medium or in a transmission signal) or hardware modules. A “hardware module” is a tangible unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors) may be configured by software (e.g., an application or application portion) as a hardware module that operates to perform certain operations as described herein.

In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a field programmable gate array (FPGA) or an ASIC. A hardware module may also include programmable logic or circuitry that is temporarily configured by software to perform certain operations. For example, a hardware module may include software encompassed within a general-purpose processor or other programmable processor. It will be appreciated that the decision to implement a hardware module mechanically, in dedicated and permanently configured circuitry, or in temporarily configured circuitry (e.g., configured by software) may be driven by cost and time considerations.

Accordingly, the phrase “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions described herein. As used herein, “processor-implemented module” refers to a hardware module implemented using one or more processors.

Similarly, the methods described herein may be at least partially processor-implemented, a processor being an example of hardware. For example, at least some of the operations of a method may be performed by one or more processors or processor-implemented modules. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an application program interface (API)).

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of this specification are presented in terms of algorithms or symbolic representations of operations on data stored as bits or binary digital signals within a machine memory (e.g., a computer memory). These algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or any suitable combination thereof), registers, or other machine components that receive, store, transmit, or display information. Furthermore, unless specifically stated otherwise, the terms “a” or “an” are herein used, as is common in patent documents, to include one or more than one instance. Finally, as used herein, the conjunction “or” refers to a non-exclusive “or,” unless specifically stated otherwise.

What is claimed is:

1. A method, comprising:
obtaining, with a processor, an optimization criterion based on at least two constraints related to interaction of members of a social network, the members including new members who have been members of the social network less than a predetermined time and established members who have been members of the social network greater than the predetermined time;
determining, with the processor, a plurality of proposed interaction values based on data stored in an electronic database, the data being indicative of at least some of profile data of members of a social network, a social graph indicative of connections between the members, and of activities of the members in the social network, each individual one of the plurality of proposed interaction values corresponding to between one of a plurality of pairs of members, the plurality of proposed interaction values including a new member proposed interaction value between at least one established member and at least one new member;
modifying, with the processor, the new member proposed interaction value based on an adjustment factor; and
providing, with the processor, to at least some of the user devices via the network interface, proposed interactions based on the new member proposed interaction value as modified and the proposed interaction value.

2. The method of claim 1, wherein one of the at least two constraints is a connection in the social network between the established member and the new member.

3. The method of claim 2, wherein another one of the at least two constraints is a connection between any of the members of the social network.

4. The method of claim 3, wherein the optimization criterion is to increase new connections between new members of the social network and all members of the social network.

5. The method of claim 4, wherein the optimization criterion is measured over a predetermined period of time.

6. The method of claim 1, wherein providing the proposed interactions includes providing the proposed interactions in an order according to the proposed interaction value as modified and the proposed interaction value.

7. The method of claim 1, the providing includes providing a predetermined number of proposed interactions and further comprising selecting the predetermined number of proposed interactions based, at least in part, on the new member proposed interaction value and the proposed interaction values.

8. The method of claim 7, wherein selecting the predetermined number of proposed interactions includes selecting the highest predetermined number of the new member proposed interaction value and the proposed interaction values.

9. The method of claim 1, wherein the adjustment factor includes a constant selectable by the processor to at least partially provide the operating condition.

10. The method of claim 9, wherein the adjustment factor further includes an adjustment score based, at least in part, on a degree of separation between the new member and the established member.

11. A computer readable medium comprising instructions that, when executed on a processor, cause the processor to implement operations comprising:
obtaining, with a processor, an optimization criterion based on at least two constraints related to interaction of members of a social network, the members including new members who have been members of the social network less than a predetermined time and established members who have been members of the social network greater than the predetermined time;
determining, with the processor, a plurality of proposed interaction values based on data stored in an electronic database, the data being indicative of at least some of profile data of members of a social network, a social graph indicative of connections between the members, and of activities of the members in the social network, each individual one of the plurality of proposed interaction values corresponding to between one of a plurality of pairs of members, the plurality of proposed interaction values including a new member proposed interaction value between at least one established member and at least one new member;
modifying, with the processor, the new member proposed interaction value based on an adjustment factor; and
providing, with the processor, to at least some of the user devices via the network interface, proposed interactions based on the new member proposed interaction value as modified and the proposed interaction value.

12. The computer readable medium of claim 11, wherein one of the at least two constraints is a connection in the social network between the established member and the new member.

13. The computer readable medium of claim 12, wherein another one of the at least two constraints is a connection between any of the members of the social network.

14. The computer readable medium of claim 13, wherein the optimization criterion is to increase new connections between new members of the social network and all members of the social network.

15. The computer readable medium of claim 14, wherein the optimization criterion is measured over a predetermined period of time.

16. The computer readable medium of claim 11, wherein providing the proposed interactions includes providing the proposed interactions in an order according to the proposed interaction value as modified and the proposed interaction value.

17. The computer readable medium of claim 11, the providing includes providing a predetermined number of proposed interactions and further comprising selecting the predetermined number of proposed interactions based, at least in part, on the new member proposed interaction value and the proposed interaction values.

18. The computer readable medium of claim 17, wherein selecting the predetermined number of proposed interactions includes selecting the highest predetermined number of the new member proposed interaction value and the proposed interaction values.

19. The computer readable medium of claim 11, wherein the adjustment factor includes a constant selectable by the processor to at least partially provide the operating condition.

20. The computer readable medium of claim 19, wherein the adjustment factor further includes an adjustment score based, at least in part, on a degree of separation between the new member and the established member.
